(19) United States
(12) Patent Application Publication
(10) Pub. No.: US 2013/0315433 A1
(43) Pub. Date: Nov. 28, 2013

(54) ELECTRONIC DEVICE WITH SPEAKER

(71) Applicants: BAO-GANG ZHAO, Shenzhen City (CN); JIAN-YONG YANG, Shenzhen City (CN)

(72) Inventors: BAO-GANG ZHAO, Shenzhen City (CN); JIAN-YONG YANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/598,640

(22) Filed: Aug. 30, 2012

(30) Foreign Application Priority Data
May 23, 2012 (CN) 201210161875.0

(51) Int. Cl. H04R 1/02

(52) U.S. Cl. 381/386

(57) ABSTRACT

An electronic device includes a front frame, a back cover coupled to the front frame, a speaker, a rubber casing to partly receive the speaker, the rubber casing being received in a cavity defined in the front frame, and a cap attached to the front frame and tightly pressing against the rubber casing, thereby holding the speaker in position.

### BACKGROUND

1. Technical Field

The present disclosure relates to an electronic device with a speaker.

2. Description of Related Art

Many electronic devices such as cellular phones and DVD players include a speaker. The speaker may be fixed to the housing of the electronic devices by screws or other suitable connection techniques. Although conventional connection techniques can satisfy basic requirements, it is still desirable and useful to provide an electronic device with a new speaker fixing mechanism.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of an electronic device in accordance with an exemplary embodiment.

FIG. 2 is an isometric, exploded view of the electronic device of FIG. 1.

FIG. 3 is an partial view of the electronic device, with certain elements omitted for clarity.

FIG. 4 is a cross-sectional view of taken along lines IV-IV of FIG. 3.

### DETAILED DESCRIPTION

Embodiments of the present disclosure will be described with reference to the accompanying drawings.

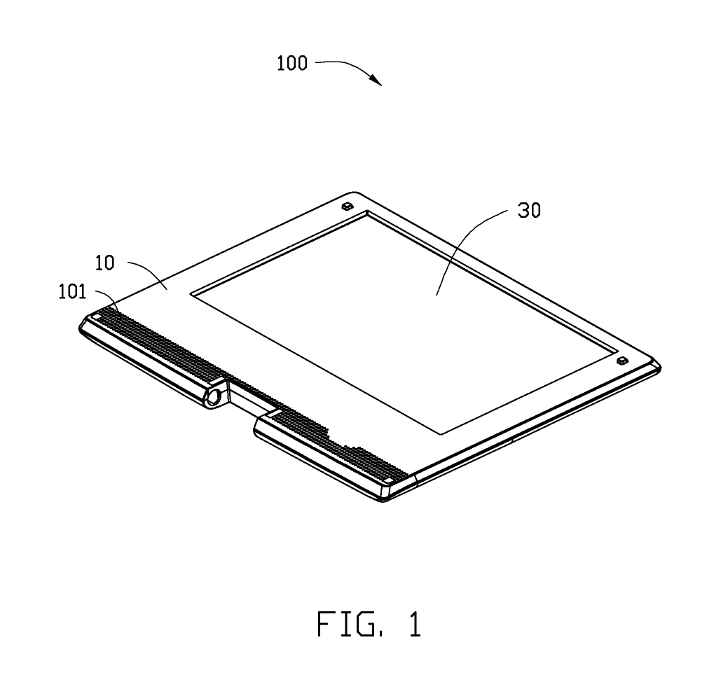

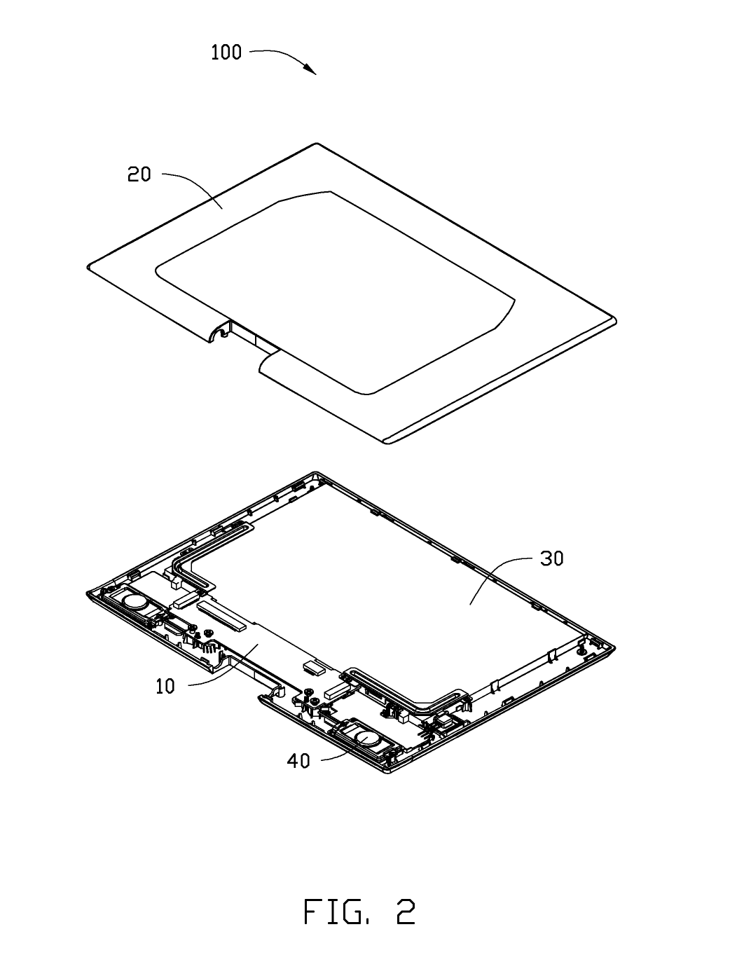

Referring to FIGS. 1 and 2, an electronic device 100 includes a front frame 10, a back cover 20, a display 30, and a speaker 40 coupled to the front frame 10. The front frame 10 defines a plurality of speaker holes 101 through which sound may be output from the speaker 40.

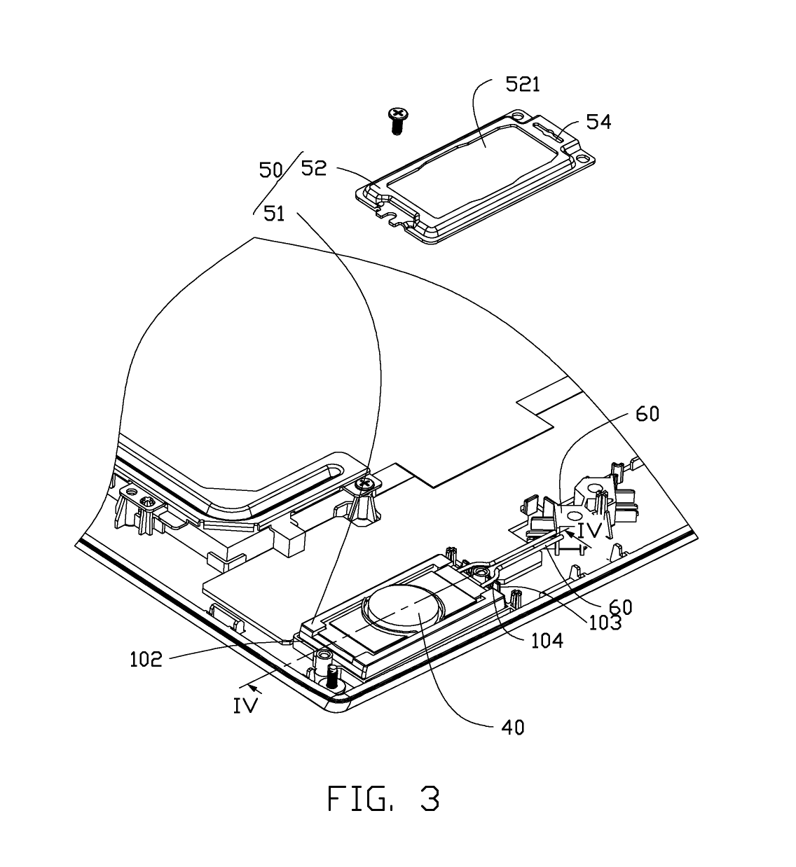

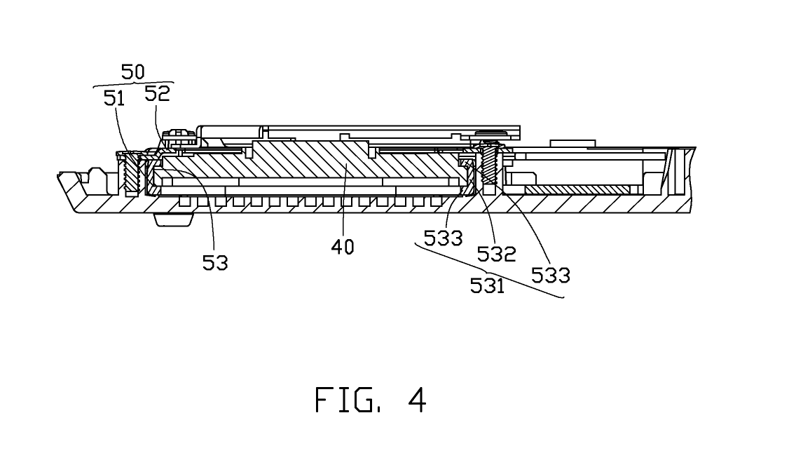

Referring to FIGS. 3 and 4, the electronic device 100 further includes a speaker fixing mechanism 50 including a rubber casing 51 and a cap 52. The rubber casing 51 defines a chamber 53 shaped corresponding to the speaker 40. The speaker 40 is partly fit into the chamber 53. The rubber casing 51 is received in a cavity 102 defined in an inner surface of the front frame 10.

The cap 52 is substantially rectangular and defines an opening 521, through which the top of the speaker 40 is exposed. The cap 52 is attached to the front frame 10 and presses tightly against the rubber casing 51, thereby tightly holding the speaker 40 in position.

The front frame 10 includes a number of tabs 103 protruding from its inner surface. Each tab 103 defines a notch 104. The cables 60 connecting the speaker 40 to a circuit board are fit into the notches 104. The cap 52 can prevent the cables 60 from disengaging from the notches 104. In the embodiment, the cap 52 further defines a slot 54 right above the protruding tabs 103. An operator can see whether the cables 60 are properly received in the notches 103 through the slot 54.

While various embodiments have been described and illustrated, the disclosure is not to be construed as being limited thereto. Various modifications can be made to the embodiments by those skilled in the art without departing from the true spirit and scope of the present disclosure as defined by the appended claims.

1. An electronic device comprising:
a front frame;
a back cover coupled to the front frame;
a speaker;
a rubber casing receiving the speaker, the rubber casing being received in a cavity defined in the front frame; and
a cap attached to the front frame and pressing the rubber casing tightly against the speaker, thereby holding the speaker in position;
wherein the rubber casing defines a chamber that comprises opposite open-end portions, each open-end portion comprises a vertical portion and two horizontal portions protruding form opposite ends of the vertical portion, each end of the speaker is fit into a space defined by the vertical portion and the two horizontal portions.

2. The electronic device according to claim 1, wherein the chamber is shaped conforming to a contour of the speaker to fittingly receive the speaker therein.

3. The electronic device according to claim 1, wherein the front frame comprises a plurality of protruding tabs, each protruding tab defines a notch receiving a corresponding cable of the speaker.

4. The electronic device according to claim 1, wherein the cap defines an opening through which the speaker is exposed.

5. The electronic device according to claim 3, wherein the cap defines a slot aligned with the protruding tabs.

6. The electronic device according to claim 1, wherein the front frame defines a plurality of speaker holes through which sound is output from the speaker.
